(19) United States
(12) Patent Application Publication
(10) Pub. No.: US 2004/0012631 A1
(43) Pub. Date: Jan. 22, 2004

(54) Master dynamic multi-catalog

(76) Inventor: Wesley Skorski, East Hampton, CT (US)

Correspondence Address: ST. ONGE STEWARD JOHNSTON & REENS, LLC, 986 BEDFORD STREET, STAMFORD, CT, 06905-5619, US

(21) Appl. No.: 10/103,592

(22) Filed: Mar. 20, 2002

Related U.S. Application Data
(60) Provisional application No. 60/277,191, filed on Mar. 20, 2001.

(51) Int. Cl. G09G 5/00

(52) U.S. Cl. 345/762

(57) ABSTRACT

A system and method of providing retailers with an online ordering system that is dynamically instantiated on use to reflect a distributor's available merchandise. The invention permits a distributor, together with the retailer, to define a product range and price and order terms that are unique to each retailer. A distributor's product database is successively filtered by templates, which are unique to each retailer, to define a unique online catalog for that retailer.

### PRIOR APPLICATION

I claim priority benefits under 35 U.S.C. §119(e) of U.S. Provisional Patent Application Serial No. 60/277,191 filed Mar. 20, 2001.

### FIELD OF THE INVENTION

The present invention relates to online electronic catalogs, and software and methods for constructing same.

### BACKGROUND OF THE INVENTION

The present invention relates generally to a data structure and method for publishing electronic catalogs. More specifically, the present invention relates to a data structure and method for publishing multiple renditions of electronic multi-manufacturer product catalogs.

Product manufacturers, particularly those involved in providing technical goods and services, traditionally use printed materials to inform the marketplace about the functionality, features, ordering procedure, etc., needed to select and specify their products. These printed catalog materials typically can take many forms (pamphlets, brochures, price books, binders, etc.), depending on the audience and level of detail of the information to be provided.

Recently, manufacturers have found the need to also deliver product information electronically. An “electronic catalog” is an electronic version of product information. The basic components common to most electronic product catalogs are a listing of product objects, a descriptive content of the products, and means for navigating through the product information. Current electronic product catalogs are available that provide various levels of product information about products that may be available from a manufacturer. Each of these catalogs may present the product information in one of several different formats. For example, one catalog may present basic pamphlet type information on a particular product line available from a single manufacturer while others may present detailed operating characteristics on many types of products available from many manufacturers.

Because product catalogs and other forms of product information are used by different individuals at various levels of an organization, or at different levels of a distribution chain, there are different types of content that may be better for the different audiences for such information.

For example, in the medical products field, some product information is directed at physicians, and some at consumers. Manufacturers' textual and media product descriptions, indexing, prices, and product offerings are constantly changing. However, conventional data structures used to maintain existing catalogs are not easily modified to accommodate such changes—particularly in product descriptions and content.

Many electronic catalogs provide for navigation by utilizing proximity key word searching within the actual textual product descriptions. However, because the terminology used in one manufacturer's product textual descriptions may differ from that of another, and because a user may not be aware of all the alternative phraseology used to describe a product for which the user is searching, conventional navigation techniques typically lead to “dead ends.”

It would be desirable to provide a data system that would permit use of a unitary database of product information which will display data according to selected criteria, and in different formats, according to the type of user that accesses the information. In such manner, different populations of users can access different catalogs built from the same data. The system should present information pertinent to the user without requiring specific knowledge or action by the user, by dynamically presenting a list of products appropriate for the situation from which the user can select, which is integrated with various levels of filter criteria.

### SUMMARY OF THE INVENTION

The invention comprises a computerized method for dynamically generating and displaying a catalog comprising a plurality of items, each item being classified by at least group information and product information.

The invention provides flexibility in constructing customized catalogs. It provides ease of use and maintenance for non-programmers. It also has the benefit of efficient storage requirements, since content text and multimedia objects are stored separately from display templates. The system provides a logical catalog architecture that is easily adapted by system operators to construct custom catalogs.

Other objects, aspects and features of the present invention in addition to those mentioned above will be pointed out in or will be understood from the following detailed description provided in conjunction with the accompanying drawings.

### BRIEF DESCRIPTION OF THE DRAWINGS

FIG. 1 is a diagram showing the steps of successive filtering of a product database to derive an online catalog for a retailer.

FIG. 2 is a diagram showing multiple different presentations of a product in different contexts.

FIG. 3 is an illustration of a web page implementing the process of the invention.

### DETAILED DESCRIPTION OF THE DRAWINGS

The present invention provides distributors with a system and method of providing their retailer customers with an online ordering system that is dynamically instantiated on use to reflect the distributor's available merchandise. The invention permits a distributor, together with the retailer, to define a product range and price and order terms that are unique to each retailer. The invention allows the retailer the opportunity to define a catalog displaying products for sale via an electronic network such as the Internet, and to offer products for sale, all without requiring a substantial investment in hardware, technology, and employees to provide such an electronic catalog. The term “retailer” herein is meant to encompass the broad range of entities that deal with consumers, and in particular includes professional offices such as physician's offices.

As noted above, one advantage of the invention is that each retailer need not have its own server to host a catalog. The catalog can be hosted on a server operated by a service bureau on a subscription basis to the retailer. Thus, multiple retailers may have their individual catalogs hosted by the same service bureau. Each catalog would have its own Internet access identifier and thus would appear from the point of view of a consumer to be unique and dedicated to a particular retailer.

The general architecture of an embodiment of the system of the invention uses a server computer that communicates with the Internet via an access port; the server uses the conventional TCP/IP protocol for communication functions between the server and client systems accessing the server over the Internet. The protocol is coupled to an Internet web server, for example, an Apache HTTP Server. The Internet web server software controls access to the Internet and provides a user interface for such access.

Working through the Internet web server is a template server. The template server is coupled to a database storage computer system which stores data and objects regarding the distributor's products. The database storage computer system may comprise a single database or a plurality of databases; the databases may be maintained by the distributor or the distributor's suppliers. The data and objects stored in the database storage computer system are filtered through the template server to dynamically generate custom electronic catalogs upon request from a consumer's computer.

The template server includes retailer specific information for each retailer, such as retailer description, custom page header and footer, contact information, tax information, shipping information, etc.

The database storage computer system includes substantial indexing information regarding each of the distributor's products. The indexing information will include a product group identification (for example “veterinary products” or “orthopedic products”) and/or an identifying code for such product group. Any item to be entered into the catalog must be assigned a product group identification and code. The product group (or subgroup) identifications are selected so that they correspond to the desired contents of at least one custom catalog. In other words, product groupings should correspond to the types of products a retailer is likely to sell in its web site.

The indexing information will also include a product information component. Product information includes product name, product SKU numbers, one or more image files; one or more text files; search keywords; price; taxes; shipping; sales or promotions; etc.

The retailer must define the parameters of the catalog. The retailer and distributor will define the criteria for the web pages to be displayed. These criteria are then embodied in filters implemented by the template server. Each catalog page displayed via retailer's web site is defined by one or more data filters related to the product group identification or code, and specific product information.

In an automated version of the system of the invention, the retailer may define the displayed information via a form based selection system. In such a system, the retailer would log onto the system with appropriate passwords, then proceed through a series of screens to select products by product group identification and then by specific products, and to select various shipping, costing or other variables. These steps define the filters operated by the template server to provide the retailer's web catalog its appropriate content and look.

Once all filters and templates have been defined by a retailer, the catalog may be accessed and used by a consumer via the internet, or by a retailer's employees via an intranet. A consumer accesses an Internet world wide web page for the retailer (or service provider for the retailer) via a web address (URL) in conventional fashion. An initial home page is displayed to the consumer. The consumer may then select a product information page and the system servers will transmit an online catalog page as customized by the retailer, by serving the consumer with a web page constructed according to the information in the database and the template server.

The steps of the process are as follows. Once the consumer selects a link requesting the online catalog, the consumer thereby generates an input request (e.g., HTML input), the template server decodes the input into a URL indicating the selected display object. The URL is then used by a page request manager to access a table of display templates stored in the database storage computer system. When the display template is found in the table, associated page information in the table is examined by a resolution manager to determine the page type. The appropriate output module(s) are then called, each of which then queries the database storage computer system for the stored pages of all of the content fields associated with the specified page. The retrieved content is then supplied to a page generation module, which generates a display page from the content and the display template associated with each stored page. The display page is then transmitted to the consumer by the web server.

Thus, for a catalog page selected by the consumer, the computer database storage computer system is queried for the information content to be displayed via the display template associated with that catalog page. Product information corresponding to the product group identification or code is retrieved so that one or more products are displayed on that catalog page. The information content is combined in a display template associated with the requested page. The rendered page may use framing or it may be rendered as a single page.

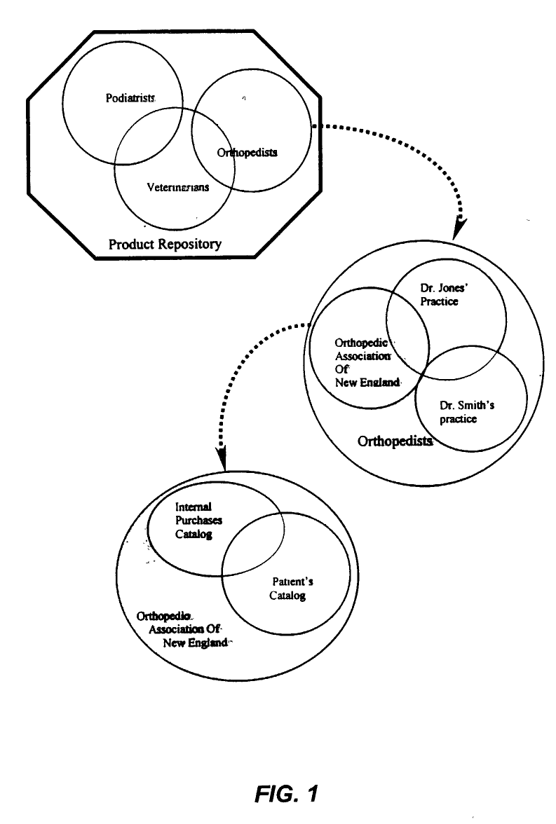

FIG. 1 schematically illustrates the above described process. A product repository, e.g. the distributor's product database, is filtered through one or more product group identifications (e.g. podiatrists products, orthopedists products, veterinarians products). The subset of product group identification for Orthopedists is further filtered differently according to specifications set by the specific retailers (Orthopedic Association of New England, or Dr. Jones, or Dr. Smith). Each retailer's information is then filtered through one of several alternative possible filters, for example, a format for an online catalog for purchases by patients; or a format for purchases by the retailer. Necessarily, in those alterative formats, the pricing for a particular item will vary, as the patient accessing the online medical store for patients will view product information and see a displayed retail price, while the retailer physician's practice will see the same item at a different price.

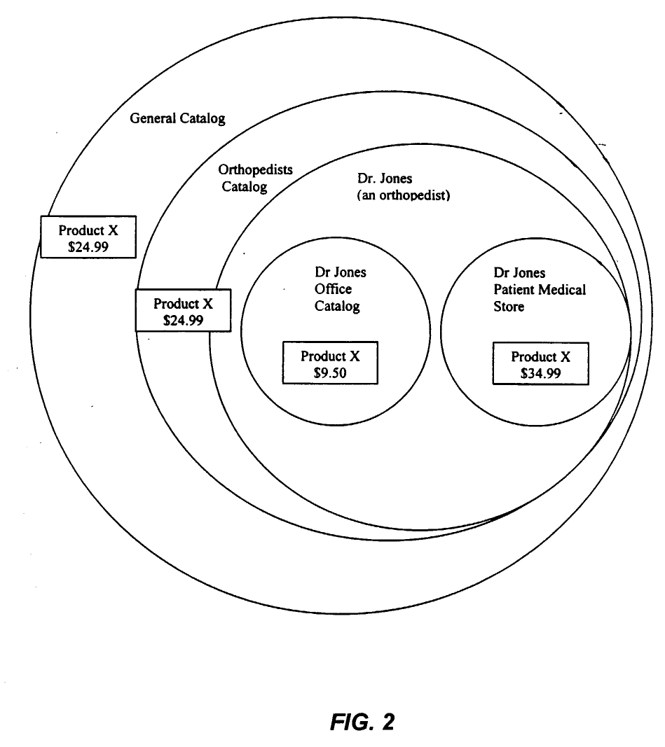

This difference is further visible in FIG. 2, which shows a diagram of how the same product might be presented differently in different online catalogs directed at different audiences. The item may appear in the distributor's product database as a product X priced at $24.99. As filtered through a product group identification, it may have the same or a different price. As shown in FIG. 2, product X appears in the Orthopedist's catalog at the same price as in the general catalog of the distributor's product database. A further filter for Dr. Jones' catalog shows two disparate catalogs: the patient medical store catalog with a higher retail price, and the office catalog, showing a discounted purchase price.

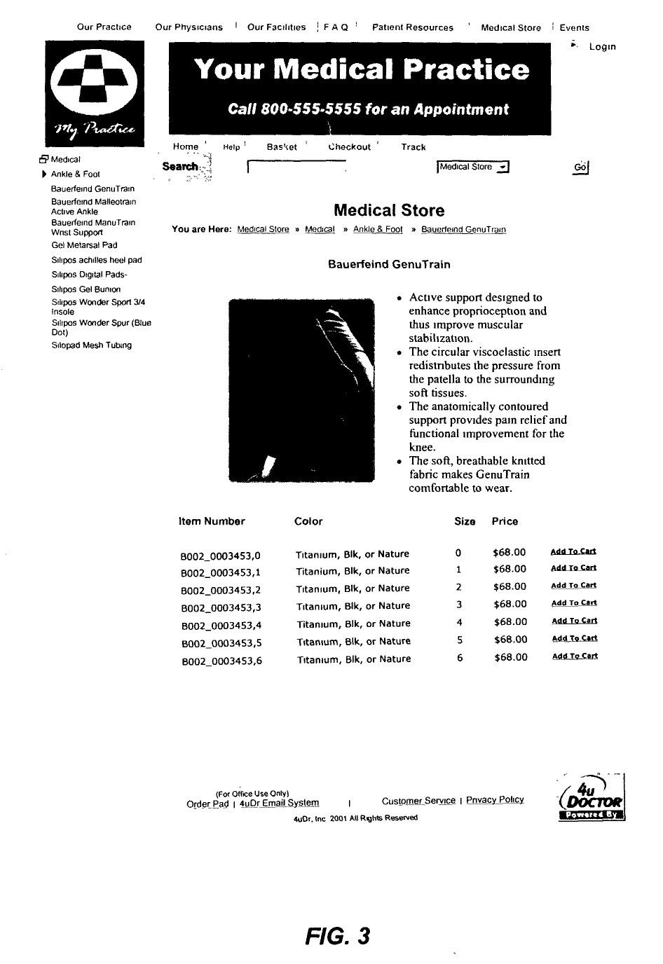

FIG. 3 is a screen display showing an example of a product display page generated in accordance with the invention. The product display page shown includes a graphical image and text describing the product. The product display page is a combination of the associated product page information originally input by the retailer with the associated display template selected by the retailer for that product. The display can be integrated with “Shopping Basket” software to enable the online order entry of a catalog item with payment via credit card.

The invention may be implemented in hardware or software, or a combination of both. However, preferably, the invention is implemented in computer programs executing on programmable computers each comprising at least one processor, a data storage system (including volatile and non-volatile memory and/or storage elements), at least one input device, and at least one output device. Program code is applied to input data to perform the functions described herein and generate output information. The output information is applied to one or more output devices, in known fashion.

The invention provides a method for quick and convenient construction of customized catalogs; is efficient in the use of storage; and allows a continuous and current access to the distributor's database of products.

Its to be appreciated that the foregoing is illustrative and not limiting of the invention, and that various changes and modifications to the preferred embodiments described above will be apparent to those skilled in the art. Such changes and modifications can be made without departing from the spirit and scope of the present invention, and it is therefore intended that such changes and modifications be covered by the following claims.

What is claimed is:

1. A computer system for providing dynamic compilation and display of a product catalog, comprising:
at least one product information database storing information relating to a plurality of products;
at least one template server for retrieving and filtering information from said product information database to selectively generate a limited data set;
at least one display server for displaying information of said limited data set according to a display template for such limited data set.

2. The computer system of claim 1 wherein said product information database comprises a product distributor's database regarding products.

3. The computer system of claim 1 wherein said product information database comprises a product distributor's database regarding medical products.

4. The computer system of claim 1 wherein said product information database comprises a plurality of product databases.

5. A method of dynamic compilation and display of a product catalog, comprising:
compiling one or more product information databases storing information relating to a plurality of products;
providing a web server with access to said product information databases, access to said product information databases being defined by one or more filters implemented by a template server, said filters selectively obtaining information from said product information database to selectively generate a limited data set;
displaying information of said limited data set according to a display template for such limited data set.

6. The method of claim 5 wherein said product information database comprises a product distributor's database regarding products.

7. The computer system of claim 5 wherein said product information database comprises a product distributor's database regarding medical products.

8. The computer system of claim 5 wherein said product information database comprises a plurality of product databases.
